(19) United States
(12) Patent Application Publication
(10) Pub. No.: US 2026/0366599 A1
(43) Pub. Date: Nov. 19, 2026

(54) COMPOSITE REDUCTION STRUCTURE, JOINT POWER MECHANISM, AND ROBOT

(71) Applicant: HANGZHOU YUSHU TECHNOLOGY CO., LTD., Zhejiang (CN)

(72) Inventor: Xingxing WANG, Hangzhou (CN)

(21) Appl. No.: 19/515,681

(22) PCT Filed: Oct. 27, 2023
(86) PCT No.: PCT/CN2023/127255

§ 371 Date: Mar. 2, 2026

(30) Foreign Application Priority Data
Sep. 1, 2023 (CN) 202311125213.2

(51) Int. Cl. F16H 1/32; B62D 57/032

(52) U.S. Cl. CPC F16H 1/32; B62D 57/032

(57) ABSTRACT

The present invention relates to the technical field of robotic devices, and discloses a composite reduction structure, a joint power mechanism, and a robot. The joint power mechanism with the composite reduction structure of the present invention uses a multi-stage reduction structure such as a first reduction unit and a second reduction unit, thereby achieving a high reduction ratio within a small structural space. In one stage of the reduction structure, a double-sided ring gear is used for meshing transmission, where the double-sided ring gear with toothed surfaces on both its internal and external sides performs eccentric motion on an internal ring gear to drive an external ring gear for output. The structure is simple and compact and achieves a large reduction ratio with fewer components compared to other reducer solutions such as planetary reducers. Moreover, during the meshing transmission of this reduction stage, the toothed surfaces remain in contact with a large contact area between the teeth and a high number of teeth in contact. Therefore, the reduction structure exhibits strong overload resistance and is less prone to damage or failure under impact loads. Thus, the structure is simple, compact, and not easily damaged or rendered inoperable.

### TECHNICAL FIELD

The present invention relates to the technical field of robotic devices, and in particular, to a composite reduction structure, a joint power mechanism, and a robot.

### BACKGROUND

Currently, reducers used in robot joint units are mostly planetary reducers, harmonic reducers, etc. These reducers have large sizes and complex structures, making them unsuitable as reducers for miniature joint units. Moreover, their poor impact resistance limits their applications.

Chinese patent application No. 202111228323.2 discloses a joint power unit with a composite reducer and a robotic arm using same. The joint power unit includes a fixing seat, and a motor unit and a reducer unit that are arranged inside the fixing seat. The reducer unit includes an internal ring gear, a flexible external ring gear arranged inside the internal ring gear, and a cam arranged inside the flexible external ring gear. The flexible external ring gear sequentially includes a meshing portion, a flexible connecting portion capable of deformation, and an output portion. The meshing portion meshes with the internal ring gear for transmission, and the number of teeth on the meshing portion is less than that of the internal ring gear. The cam abuts against the meshing portion and rotates relative to the meshing portion to drive the meshing portion to roll inside the internal ring gear. When the internal ring gear is fixed, the meshing portion rolls inside the internal ring gear, driving the output portion to rotate through the flexible connecting portion.

### SUMMARY

### Technical Problem

In the above technical solution, the reducer unit uses the cam, the internal ring gear, and the flexible external ring gear to achieve reduction transmission, resulting in a relatively complex structure and operating principle. Moreover, the deformable flexible connecting portion included in the flexible external ring gear is prone to fatigue damage and failure during reciprocating deformation, and exhibits poor impact resistance. Furthermore, the transmission relies on only two stages of speed reduction, resulting in a relatively small reduction ratio.

The information disclosed in this background section is only for understanding the background of the concept of the present invention, and therefore may include information that does not constitute the prior art.

### Technical Solution

Aiming at the above problems or one of the above problems, a first objective of the present invention is to provide a joint power mechanism with a composite reduction structure, which adopts multi-stage reduction transmission, and in which one stage of reduction transmission is provided with a double-sided ring gear between an internal ring gear and an external ring gear, forming a multi-layer meshing transmission structure, with high overall reduction ratio and strong structural impact resistance.

Aiming at the above problems or one of the above problems, a second objective of the present invention is to provide a general-purpose humanoid robot, including a joint power mechanism with a composite reduction structure mounted at its joints, which adopts multi-stage reduction transmission, and in which one stage of reduction transmission is provided with a double-sided ring gear between an internal ring gear and an external ring gear, forming a multi-layer meshing transmission structure, with high overall reduction ratio and strong structural impact resistance.

Aiming at the above problems or one of the above problems, a third objective of the present invention is to provide a composite reduction structure, which is provided with a first reduction unit and a second reduction unit, forming a multi-stage reduction structure, thus allowing a relatively high reduction ratio to be obtained within a relatively small structural space, and which employs a double-sided ring gear for meshing transmission, the double-sided ring gear performing eccentric motion on an internal ring gear to drive an external ring gear or internal ring gear for output, featuring a simple and compact structure, an overall high reduction ratio, and strong structural impact resistance.

To achieve one of the above objectives, a first technical solution of the present invention is as follows.

There is provided a joint power mechanism with a composite reduction structure, including a motor unit, and a first reduction unit and a second reduction unit that transmit power sequentially, wherein the first reduction unit includes a cylindrical gear set and/or a bevel gear set, and the second reduction unit includes a transmission shaft, a double-sided ring gear with toothed surfaces on both internal and external sides, an internal ring gear, and an external ring gear;
the transmission shaft is provided with an eccentric wheel whose geometric center is offset from its rotational center;
the number of teeth on the external side of the double-sided ring gear differs by one tooth from the number of teeth on an internal side of the internal ring gear, and the number of teeth on the internal side of the double-sided ring gear differs by one tooth from the number of teeth on an external side of the external ring gear; and
the eccentric wheel is capable of driving the double-sided ring gear to perform eccentric rotation, and the double-sided ring gear is capable of always remaining partially meshed with the internal ring gear and the external ring gear, respectively, for transmission and is capable of outputting power through the internal ring gear or the external ring gear.

A preferred technical measure is as follows.

The first reduction unit includes a first cylindrical gear and a second cylindrical gear that are in mesh with each other and have rotational centers parallel to each other, and a first bevel gear and a second bevel gear that are in mesh with each other and have rotational centers perpendicular to each other, wherein the first cylindrical gear is coaxially and fixedly connected to an output shaft of the motor unit, and the first bevel gear is coaxially and fixedly connected to the second cylindrical gear, and the second bevel gear is coaxially and fixedly connected to the transmission shaft. The reduction unit employs bevel gear transmission to achieve a 90-degree angle between the input end and the output end, where different input and output angles are suitable for various scenarios, thereby enhancing the adaptability of this joint power mechanism.

Alternatively, the first reduction unit includes a first cylindrical gear and a second cylindrical gear that are in mesh with each other and have rotational centers parallel to each other, and a third cylindrical gear and a fourth cylindrical gear that are in mesh with each other and have rotational centers parallel to each other, wherein the first cylindrical gear is coaxially and fixedly connected to the output shaft of the motor unit, and the third cylindrical gear is coaxially and fixedly connected to the second cylindrical gear, and the fourth cylindrical gear is coaxially and fixedly connected to the transmission shaft. The reduction unit employs cylindrical gear transmission, with parallel input and output ends, where different input and output angles are suitable for various scenarios, thereby enhancing the adaptability of this joint power mechanism.

Alternatively, the first reduction unit includes at least two cylindrical gear sets, each cylindrical gear set including at least two cylindrical gears in mesh with each other, so as to increase the reduction ratio of the first reduction unit.

A preferred technical measure is as follows.

The double-sided ring gear is fixed to the eccentric wheel via a first bearing; and an internal side of the double-sided ring gear is provided with a toothed surface on one axial segment for meshing with the external ring gear, and is provided with an assembly surface on another axial segment for fixing the first bearing.

A preferred technical measure is as follows.

The motor unit, the first reduction unit, and the second reduction unit are all arranged inside a base, the internal ring gear is directly fixed inside the base, the external ring gear extends outward from the base to form an output portion, and the external ring gear serves as an output shaft to output power with reduced speed;
or, the external ring gear is fixed to the base, and the internal ring gear serves as an output shaft to output power with reduced speed.

A preferred technical measure is as follows.

The external ring gear is fixed inside the base via a second bearing; the transmission shaft has one end fixed inside the base via a third bearing and the other end fixed inside the external ring gear via a fourth bearing;
and/or, the motor unit includes a motor, which is a coreless motor or a brushless motor, a rotary encoder being installed at a rotor end of the motor, and a motor drive circuit board being installed on a lateral side of the motor.

To achieve one of the above objectives, a second technical solution of the present invention is as follows.

There is provided a composite reduction structure, including a first reduction unit and a second reduction unit for connecting to a motor unit, wherein the first reduction unit is provided with a gear set capable of transmitting power from the motor unit; the second reduction unit includes a transmission shaft, a double-sided ring gear, an internal ring gear, and an external ring gear;
the transmission shaft has one end provided with an eccentric wheel and the other end connected to the gear set of the first reduction unit; and
the gear set of the first reduction unit is capable of driving the transmission shaft to rotate, such that the eccentric wheel on the transmission shaft can drive the double-sided ring gear to perform eccentric rotation, thereby enabling the double-sided ring gear to mesh with the internal ring gear and the external ring gear, respectively, for transmission.

According to the present invention, through continuous exploration and experimentation, an arrangement of the first reduction unit and the second reduction unit is provided, forming a multi-stage reduction structure, which allows for a relatively high reduction ratio to be obtained within a relatively small structural space, and which employs the double-sided ring gear for meshing transmission, the double-sided ring gear performing eccentric motion on the internal ring gear to drive the external ring gear or internal ring gear for output, featuring a simple and compact structure.

Further, compared to other reducer solutions such as planetary reducers, the present invention requires fewer components to achieve the same reduction ratio; and the multi-stage reduction structure of the present invention can perform eccentric motion, such that during meshing transmission, the contact is mainly between the toothed surfaces, featuring a large contact area and a high number of teeth in contact, and therefore, the reduction structure exhibits strong overload resistance and is less prone to damage or failure caused by impact loads. Thus, the structure of the present invention is simple, compact, and not easily damaged or rendered inoperable.

A preferred technical measure is as follows.

The gear set is a cylindrical gear set and/or a bevel gear set;
or, the gear set includes a first cylindrical gear and a second cylindrical gear that are in mesh with each other and have rotational centers parallel to each other, and a first bevel gear and a second bevel gear that are in mesh with each other and have rotational centers perpendicular to each other, wherein the first cylindrical gear is coaxially and fixedly connected to an output shaft of the motor unit, and the first bevel gear is coaxially and fixedly connected to the second cylindrical gear, and the second bevel gear is coaxially and fixedly connected to the transmission shaft;
or, the gear set includes a first cylindrical gear and a second cylindrical gear that are in mesh with each other and have rotational centers parallel to each other, and a third cylindrical gear and a fourth cylindrical gear that are in mesh with each other and have rotational centers parallel to each other, wherein the first cylindrical gear is coaxially and fixedly connected to the output shaft of the motor unit, and the third cylindrical gear is coaxially and fixedly connected to the second cylindrical gear, and the fourth cylindrical gear is coaxially and fixedly connected to the transmission shaft;
and/or, the transmission shaft is of a rod-shaped structure, a strip-shaped structure, or a diameter-varying structure;
and/or, internal and external sides of the double-sided ring gear are each provided with a toothed surface.

To achieve one of the above objectives, a third technical solution of the present invention is as follows.

There is provided a joint power mechanism with a composite reduction structure, including a motor unit having a rotor end, a first reduction unit assembled with the rotor end, and a second reduction unit assembled with the first reduction unit, wherein the first reduction unit is provided with a gear set; the second reduction unit includes a transmission shaft, a double-sided ring gear with toothed surfaces on both internal and external sides, an internal ring gear, and an external ring gear;
the transmission shaft has one end provided with an eccentric wheel and the other end connected to the gear set of the first reduction unit; and
the gear set of the first reduction unit is capable of driving the transmission shaft to rotate, such that the eccentric wheel on the transmission shaft can drive the double-sided ring gear to perform eccentric rotation, thereby enabling the double-sided ring gear to mesh with the internal ring gear and the external ring gear, respectively, to output power, or the external ring gear to output power.

According to the present invention, through continuous exploration and experimentation, an arrangement of the first reduction unit and the second reduction unit is provided, forming a multi-stage reduction structure, which allows for a relatively high reduction ratio to be obtained within a relatively small structural space, and which employs the double-sided ring gear for meshing transmission, the double-sided ring gear performing eccentric motion on the internal ring gear to drive the external ring gear or internal ring gear for output, featuring a simple and compact structure.

Further, compared to other reducer solutions such as planetary reducers, the present invention requires fewer components to achieve the same reduction ratio; and the multi-stage reduction structure of the present invention can perform eccentric motion, such that during meshing transmission, the contact is mainly between the toothed surfaces, featuring a large contact area and a high number of teeth in contact, and therefore, the reduction structure exhibits strong overload resistance and is less prone to damage or failure caused by impact loads. Thus, the structure of the present invention is simple, compact, and not easily damaged or rendered inoperable.

A preferred technical measure is as follows.

The gear set is arranged vertically such that a force from the motor unit is transmitted vertically; and
the transmission shaft is arranged horizontally with its extension direction parallel to an extension direction of the rotor end, forming an n-shaped power transmission structure, which further reduces the assembly space required by the joint power mechanism and makes the structure of the joint power mechanism more compact.

Alternatively/additionally, the motor unit, the first reduction unit, and the second reduction unit are all arranged inside a base, the base is provided with a first through-hole for assembling the motor unit and a second through-hole for outputting power, and the first through-hole and the second through-hole are located on the same plane in such a manner that vertical projections of input and output centers of the joint power mechanism coincide, forming a reduction structure with a U-shaped force path, which further reduces the assembly space required by the joint power mechanism and makes the structure of the joint power mechanism more compact.

To achieve one of the above objectives, a fourth technical solution of the present invention is as follows.

There is provided a robot, which is a general-purpose humanoid robot or a quadruped robot, including a joint power mechanism with a composite reduction structure as described above, or a composite reduction structure as described above.

### Beneficial Effects

According to the present invention, through continuous exploration and experimentation, an arrangement of the first reduction unit and the second reduction unit is provided, forming a multi-stage reduction structure, which allows for a relatively high reduction ratio to be obtained within a relatively small structural space, and which employs the double-sided ring gear for meshing transmission, the double-sided ring gear performing eccentric motion on the internal ring gear to drive the external ring gear or internal ring gear for output, featuring a simple and compact structure.

Further, compared to other reducer solutions such as planetary reducers, the present invention requires fewer components to achieve the same reduction ratio; and the multi-stage reduction structure of the present invention can perform eccentric motion, such that during meshing transmission, the contact is mainly between the toothed surfaces, featuring a large contact area and a high number of teeth in contact, and therefore, the reduction structure exhibits strong overload resistance and is less prone to damage or failure caused by impact loads. Thus, the structure of the present invention is simple, compact, and not easily damaged or rendered inoperable.

Still further, the joint power mechanism with the composite reduction structure and the robot according to the present invention uses a multi-stage reduction structure such as a first reduction unit and a second reduction unit, thereby achieving a high reduction ratio within a relatively small structural space. In one stage of the reduction structure, a double-sided ring gear is used for meshing transmission, where the double-sided ring gear, which has toothed surfaces on both its internal and external sides, performs eccentric motion on an internal ring gear to drive an external ring gear for output. The structure is simple and compact, and compared to other reducer solutions such as planetary reducers, a large reduction ratio can be achieved with fewer components. Moreover, during the meshing transmission of this reduction stage, the toothed surfaces remain in contact with a large contact area between the teeth and a high number of teeth in contact. As a result, the reduction structure exhibits strong overload resistance and is less prone to damage or failure caused by impact loads. Thus, the structure is simple, compact, and not easily damaged or rendered inoperable.

### BRIEF DESCRIPTION OF DRAWINGS

FIG. 1 is a schematic diagram of an overall structure of a joint power mechanism with a composite reduction structure according to the present invention;

FIG. 2 is a full-sectional schematic diagram of a joint power mechanism with a composite reduction structure according to the present invention;

FIG. 3 is an exploded view of a joint power mechanism with a composite reduction structure according to the present invention;

FIG. 4 is a schematic diagram of another overall structure of a joint power mechanism with a composite reduction structure according to the present invention;

FIG. 5 is another full-sectional schematic diagram of a joint power mechanism with a composite reduction structure according to the present invention; and

FIG. 6 is another exploded view of a joint power mechanism with a composite reduction structure according to the present invention.

In the accompanying drawings: 1, motor unit; 21, first cylindrical gear; 22, second cylindrical gear; 31, transmission shaft; 32, double-sided ring gear; 321, toothed surface; 322, assembly surface; 33, internal ring gear; 34, external ring gear; 35, eccentric wheel; 41, first bevel gear; 42, second bevel gear; 51, third cylindrical gear; 52, fourth cylindrical gear; 61, first bearing; 62, second bearing; 63, third bearing; 64, fourth bearing; 7, base; 8, output portion.

### DETAILED DESCRIPTION

In order to make the objectives, technical solutions and advantages of the present invention more apparent, the present invention is further described in detail with reference to the accompanying drawings and embodiments. It should be understood that the specific embodiments described herein are intended only to explain the present invention and are not intended to limit the present invention.

On the contrary, the present invention encompasses any alternatives, modifications, equivalent methods, and solutions that fall within the spirit and scope of the present invention as defined by the claims. Furthermore, to enable the public to have a better understanding of the present invention, certain specific details are described in detail in the following detailed description of the present invention. Those skilled in the art can fully understand the present invention without the description of these details.

It should be noted that when two components are “fixedly connected” or “rotatably connected,” the two components may be directly connected or there may be an intermediate component therebetween. Conversely, when a component is referred to as being “directly on” another component, there is no intermediate component. The terms “internal,” “external,” “horizontal,” “vertical,” “upper,” “lower,” and similar expressions used herein are for illustrative purposes only.

Unless otherwise defined, all the technical and scientific terms used herein have the same meanings as those commonly understood by those skilled in the art to which the present invention pertains. The terms used herein are merely for the purpose of describing particular embodiments, but are not intended to limit the present invention. As used herein, the term “and/or” includes any and all combinations of one or more related items listed.

A specific embodiment of the composite reduction structure of the present invention is as follows.

There is provided a composite reduction structure, including a first reduction unit and a second reduction unit for connecting to a motor unit, wherein the first reduction unit is provided with a gear set capable of transmitting power from the motor unit;
the second reduction unit includes a transmission shaft, a double-sided ring gear, an internal ring gear, and an external ring gear;
the transmission shaft has one end provided with an eccentric wheel and the other end connected to the gear set of the first reduction unit; and
the gear set of the first reduction unit is capable of driving the transmission shaft to rotate, such that the eccentric wheel on the transmission shaft can drive the double-sided ring gear to perform eccentric rotation, thereby enabling the double-sided ring gear to mesh with the internal ring gear and the external ring gear, respectively, for transmission.
the gear set of the first reduction unit is capable of driving the transmission shaft to rotate, such that the eccentric wheel on the transmission shaft can drive the double-sided ring gear to perform eccentric rotation, thereby enabling the double-sided ring gear to mesh with the internal ring gear and the external ring gear, respectively, for transmission.

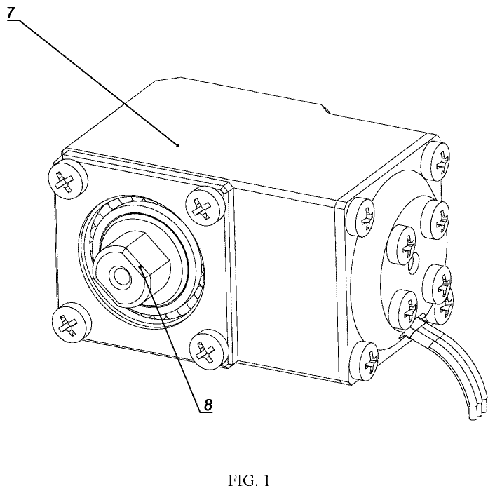

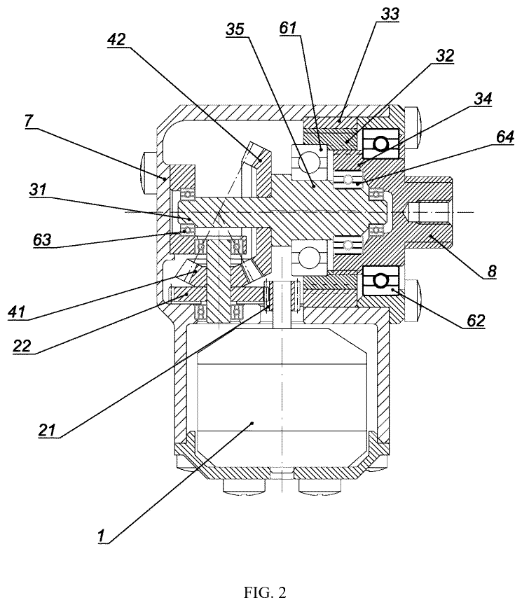

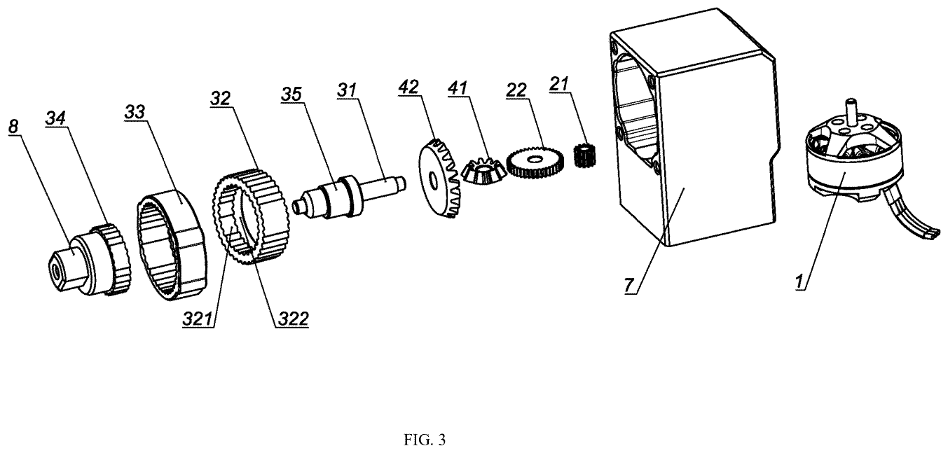

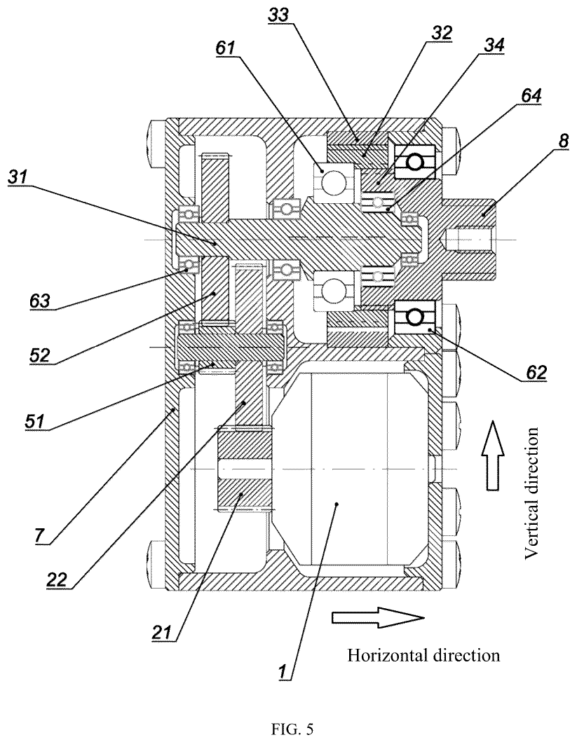

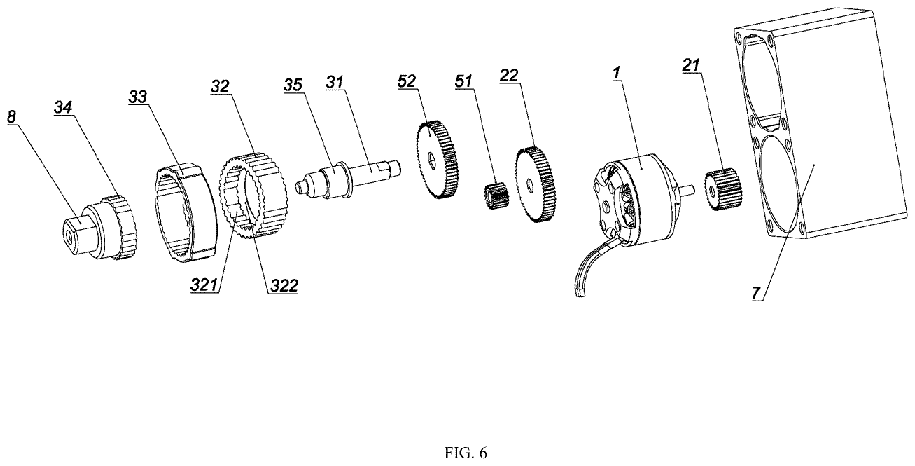

As shown in FIGS. 1, 2, 3, 4, 5, and 6, a first specific embodiment of a joint power mechanism with a composite reduction structure of the present invention is as follows.

There is provided a joint power mechanism with a composite reduction structure, including a motor unit 1 having a rotor end, a first reduction unit assembled with the rotor end, and a second reduction unit assembled with the first reduction unit, where
the first reduction unit is provided with a gear set;
the second reduction unit includes a transmission shaft 31, a double-sided ring gear 32 with toothed surfaces 321 on both internal and external sides, an internal ring gear 33, and an external ring gear 34;
the transmission shaft 31 has one end provided with an eccentric wheel 35 and the other end connected to the gear set of the first reduction unit; and
the gear set of the first reduction unit is capable of driving the transmission shaft 31 to rotate, such that the eccentric wheel 35 on the transmission shaft 31 can drive the double-sided ring gear 32 to perform eccentric rotation, thereby enabling the double-sided ring gear 32 to mesh with the internal ring gear 33 and the external ring gear 34, respectively, to output power, or the external ring gear 34 to output power

A second specific embodiment of a joint power mechanism with a composite reduction structure according to the present invention is as follows.

There is provided a joint power mechanism with a composite reduction structure, including a motor unit 1, and a first reduction unit and a second reduction unit that transmit power sequentially, wherein the first reduction unit includes a cylindrical gear set and/or a bevel gear set;
the second reduction unit includes a transmission shaft 31, a double-sided ring gear 32 with toothed surfaces 321 on both internal and external sides, an internal ring gear 33, and an external ring gear 34; the transmission shaft 31 is provided with an eccentric wheel 35 whose geometric center is offset from its rotational center; the number of teeth on the external side of the double-sided ring gear 32 differs by one tooth from the number of teeth on an internal side of the internal ring gear 33, and the number of teeth on the internal side of the double-sided ring gear 32 differs by one tooth from the number of teeth on an external side of the external ring gear 34; and the eccentric wheel 35 drives the double-sided ring gear 32 to perform eccentric rotation, and the double-sided ring gear 32 always remains partially meshed with the internal ring gear 33 and the external ring gear 34, respectively, for transmission and outputs power through the external ring gear 34.

As shown in FIGS. 1, 2, and 3, a third specific embodiment of a joint power mechanism with a composite reduction structure according to the present invention is as follows.

There is provided a joint power mechanism with a composite reduction structure, including a motor unit 1, and a first reduction unit and a second reduction unit that transmit power sequentially.

The first reduction unit includes a first cylindrical gear 21 and a second cylindrical gear 22 that are in mesh with each other and have rotational centers parallel to each other, and a first bevel gear 41 and a second bevel gear 42 that are in mesh with each other and have rotational centers perpendicular to each other, wherein the first cylindrical gear 21 is coaxially and fixedly connected to an output shaft of the motor unit 1, and the first bevel gear 41 is coaxially and fixedly connected to the second cylindrical gear 22, and the second bevel gear 42 is coaxially and fixedly connected to the transmission shaft 31. The reduction unit employs bevel gear transmission to achieve a 90-degree angle between the input end and the output end, where different input and output angles are suitable for various scenarios, thereby enhancing the adaptability of this joint power mechanism.

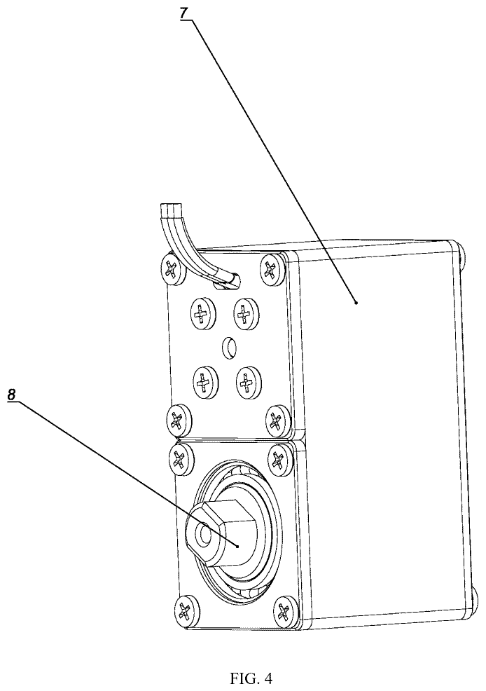

As shown in FIGS. 4, 5, and 6, a fourth specific embodiment of a joint power mechanism with a composite reduction structure according to the present invention is as follows.

There is provided a joint power mechanism with a composite reduction structure, including a motor unit 1, and a first reduction unit and a second reduction unit that transmit power sequentially.

The first reduction unit includes a first cylindrical gear 21 and a second cylindrical gear 22 that are in mesh with each other and have rotational centers parallel to each other, and a third cylindrical gear 51 and a fourth cylindrical gear 52 that are in mesh with each other and have rotational centers parallel to each other, where the first cylindrical gear 21 is coaxially and fixedly connected to the output shaft of the motor unit 1, and the third cylindrical gear 51 is coaxially and fixedly connected to the second cylindrical gear 22, and the fourth cylindrical gear 52 is coaxially and fixedly connected to the transmission shaft 31. The reduction unit employs cylindrical gear transmission, with parallel input and output ends, where different input and output angles are suitable for various scenarios, thereby enhancing the adaptability of this joint power mechanism.

A specific embodiment of the double-sided ring gear 32 of the present invention is as follows.

The double-sided ring gear 32 is fixed to the eccentric wheel 35 via a first bearing 61; and an internal side of the double-sided ring gear 32 is provided with a toothed surface 321 on one axial segment for meshing with the external ring gear 34, and is provided with an assembly surface 322 on another axial segment for fixing the first bearing 61.

A specific embodiment of the present invention with an additional base 7 is as follows.

The motor unit 1, the first reduction unit, and the second reduction unit are all arranged inside a base 7, the internal ring gear 33 is directly fixed inside the base 7, the external ring gear 34 extends outward from the base 7 to form an output portion 8, and the external ring gear 34 serves as an output shaft to output power with reduced speed.

Alternatively, the external ring gear 34 is fixed to the base 7, and the internal ring gear 33 serves as an output shaft to output power with reduced speed.

The external ring gear 34 is fixed inside the base 7 via a second bearing 62; and the transmission shaft 31 has one end fixed inside the base 7 via a third bearing 63 and the other end fixed inside the external ring gear 34 via a fourth bearing 64.

A specific embodiment of the motor unit 1 of the present invention is as follows.

The motor unit 1 includes a motor, which is a coreless motor or a brushless motor, a rotary encoder being installed at a rotor end of the motor, and a motor drive circuit board being installed on a lateral side of the motor.

A specific embodiment of a general-purpose humanoid robot applying the present invention is as follows.

There is provided a general-purpose humanoid robot, including a joint power mechanism with a composite reduction structure as described above.

A specific embodiment of a quadruped robot applying the present invention is as follows.

There is provided a quadruped robot, including a joint power mechanism with a composite reduction structure as described above.

In this application, the fixing connection method may be screw connection, riveting, plug-in connection, or connection via a third component, and those skilled in the art can make selections based on actual circumstances.

Finally, it should be noted that the above embodiments are only used to illustrate the technical solutions of the present invention and are not intended to limit the present invention. Although the present invention has been described in detail with reference to the above embodiments, those of ordinary skill in the art should understand that modifications or equivalent replacements to the specific implementations of the present invention can still be made, and any modifications or equivalent replacements that do not depart from the spirit and scope of the present invention shall fall within the scope of protection of the claims of the present invention.

1. A joint power mechanism with a composite reduction structure, the joint power mechanism comprising
a motor unit, and a first reduction unit and a second reduction unit that transmit power sequentially, wherein the first reduction unit comprises a cylindrical gear set and/or a bevel gear set, and the second reduction unit comprises a transmission shaft, a double-sided ring gear with toothed surfaces on both internal and external sides, an internal ring gear, and an external ring gear;
the transmission shaft is provided with an eccentric wheel whose geometric center is offset from a rotational center thereof;
the number of teeth on the external side of the double-sided ring gear differs by one tooth from the number of teeth on an internal side of the internal ring gear, and the number of teeth on the internal side of the double-sided ring gear differs by one tooth from the number of teeth on an external side of the external ring gear; and
the eccentric wheel is capable of driving the double-sided ring gear to perform eccentric rotation, and the double-sided ring gear is capable of always remaining partially meshed with the internal ring gear and the external ring gear, respectively, for transmission and is capable of outputting power through the internal ring gear or the external ring gear.

2. The joint power mechanism with the composite reduction structure of claim 1, wherein
the first reduction unit comprises a first cylindrical gear and a second cylindrical gear that are in mesh with each other and have rotational centers parallel to each other, and a first bevel gear and a second bevel gear that are in mesh with each other and have rotational centers perpendicular to each other, wherein the first cylindrical gear is coaxially and fixedly connected to an output shaft of the motor unit, and the first bevel gear is coaxially fixedly connected to the second cylindrical gear, and the second bevel gear is coaxially and fixedly connected to the transmission shaft;
or, the first reduction unit comprises a first cylindrical gear and a second cylindrical gear that are in mesh with each other and have rotational centers parallel to each other, and a third cylindrical gear and a fourth cylindrical gear that are in mesh with each other and have rotational centers parallel to each other, wherein the first cylindrical gear is coaxially and fixedly connected to the output shaft of the motor unit, and the third cylindrical gear is coaxially and fixedly connected to the second cylindrical gear, and the fourth cylindrical gear is coaxially and fixedly connected to the transmission shaft;
or, the first reduction unit comprises at least two cylindrical gear sets, each cylindrical gear set comprising at least two cylindrical gears in mesh with each other.

3. The joint power mechanism with the composite reduction structure of claim 2, wherein
the double-sided ring gear is fixed to the eccentric wheel via a first bearing; and an internal side of the double-sided ring gear is provided with a toothed surface on one axial segment for meshing with the external ring gear, and is provided with an assembly surface on another axial segment for fixing the first bearing.

4. The joint power mechanism with the composite reduction structure of claim 3, wherein
the motor unit, the first reduction unit, and the second reduction unit are all arranged inside a base the internal ring gear is directly fixed inside the base, the external ring gear extends outward from the base to form an output portion, and the external ring gear serves as an output shaft to output power with reduced speed;
or, the external ring gear is fixed to the base, and the internal ring gear serves as an output shaft to output power with reduced speed.

5. The joint power mechanism with the composite reduction structure of claim 4, wherein
the external ring gear is fixed inside the base via a second bearing; the transmission shaft has one end fixed inside the base via a third bearing and the other end fixed inside the external ring gear via a fourth bearing;
and/or, the motor unit comprises a motor, which is a coreless motor or a brushless motor, a rotary encoder being installed at a rotor end of the motor, and a motor drive circuit board being installed on a lateral side of the motor.

6. A composite reduction structure, comprising
a first reduction unit and a second reduction unit for connecting to a motor unit, wherein
the first reduction unit is provided with a gear set capable of transmitting power from the motor unit;
the second reduction unit comprises a transmission shaft, a double-sided ring gear, an internal ring gear, and an external ring gear;
the transmission shaft has one end provided with an eccentric wheel and the other end connected to the gear set of the first reduction unit; and
the gear set of the first reduction unit is capable of driving the transmission shaft to rotate, such that the eccentric wheel on the transmission shaft can drive the double-sided ring gear to perform eccentric rotation, thereby enabling the double-sided ring gear to mesh with the internal ring gear and the external ring gear, respectively, for transmission.

7. The composite reduction structure of claim 6, wherein
the gear set is a cylindrical gear set and/or a bevel gear set;
or, the gear set comprises a first cylindrical gear and a second cylindrical gear that are in mesh with each other and have rotational centers parallel to each other, and a first bevel gear and a second bevel gear that are in mesh with each other and have rotational centers perpendicular to each other, wherein the first cylindrical gear is coaxially and fixedly connected to an output shaft of the motor unit, and the first bevel gear is coaxially and fixedly connected to the second cylindrical gear, and the second bevel gear is coaxially and fixedly connected to the transmission shaft;
or, the gear set comprises a first cylindrical gear and a second cylindrical gear-(22) that are in mesh with each other and have rotational centers parallel to each other, and a third cylindrical gear and a fourth cylindrical gear that are in mesh with each other and have rotational centers parallel to each other, wherein the first cylindrical gear is coaxially and fixedly connected to the output shaft of the motor unit, and the third cylindrical gear is coaxially and fixedly connected to the second cylindrical gear, and the fourth cylindrical gear is coaxially and fixedly connected to the transmission shaft;
and/or, the transmission shaft is of a rod-shaped structure, a strip-shaped structure, or a diameter-varying structure;
and/or, internal and external sides of the double-sided ring gear are each provided with a toothed surface.

8. (canceled)

9. (canceled)

10. (canceled)

11. A joint power mechanism with a composite reduction structure, comprising
a motor unit having a rotor end, a first reduction unit assembled with the rotor end, and a second reduction unit assembled with the first reduction unit, wherein
the first reduction unit is provided with a gear set;
the second reduction unit comprises a transmission shaft, a double-sided ring gear with toothed surfaces on both internal and external sides, an internal ring gear, and an external ring gear;
the transmission shaft has one end provided with an eccentric wheel and the other end connected to the gear set of the first reduction unit; and
the gear set of the first reduction unit is capable of driving the transmission shaft to rotate, such that the eccentric wheel on the transmission shaft can drive the double-sided ring gear to perform eccentric rotation, thereby enabling the double-sided ring gear to mesh with the internal ring gear and the external ring gear, respectively, to output power, or the external ring gear to output power.

12. The joint power mechanism with the composite reduction structure of claim 11, wherein
the gear set is arranged vertically such that a force from the motor unit is transmitted vertically;
the transmission shaft is arranged horizontally with its extension direction parallel to an extension direction of the rotor end, forming an n-shaped power transmission structure;
and/or, the motor unit, the first reduction unit, and the second reduction unit are all arranged within a base, the base is provided with a first through-hole for assembling the motor unit and a second through-hole for outputting power, and the first through-hole and the second through-hole are located on the same plane in such a manner that vertical projections of input and output centers of the joint power mechanism coincide, forming a reduction structure with a U-shaped force path.

13. A robot, wherein the robot is a general-purpose humanoid robot or a quadruped robot and comprises a joint power mechanism with the composite reduction structure;
the joint power mechanism with a composite reduction structure, the joint power mechanism comprising
a motor unit, and a first reduction unit and a second reduction unit that transmit power sequentially, wherein the first reduction unit comprises a cylindrical gear set and/or a bevel gear set, and the second reduction unit comprises a transmission shaft, a double-sided ring gear with toothed surfaces on both internal and external sides, an internal ring gear, and an external ring gear;
the transmission shaft is provided with an eccentric wheel whose geometric center is offset from a rotational center thereof;
the number of teeth on the external side of the double-sided ring gear differs by one tooth from the number of teeth on an internal side of the internal ring gear, and the number of teeth on the internal side of the double-sided ring gear differs by one tooth from the number of teeth on an external side of the external ring gear; and
the eccentric wheel is capable of driving the double-sided ring gear to perform eccentric rotation, and the double-sided ring gear is capable of always remaining partially meshed with the internal ring gear and the external ring gear, respectively, for transmission and is capable of outputting power through the internal ring gear or the external ring gear;
or the joint power mechanism with a composite reduction structure, comprising
a motor unit having a rotor end, a first reduction unit assembled with the rotor end, and a second reduction unit assembled with the first reduction unit, wherein
the first reduction unit is provided with a gear set;
the second reduction unit comprises a transmission shaft, a double-sided ring gear with toothed surfaces on both internal and external sides, an internal ring gear, and an external ring gear;
the transmission shaft has one end provided with an eccentric wheel and the other end connected to the gear set of the first reduction unit; and
the gear set of the first reduction unit is capable of driving the transmission shaft to rotate, such that the eccentric wheel on the transmission shaft can drive the double-sided ring gear to perform eccentric rotation, thereby enabling the double-sided ring gear to mesh with the internal ring gear and the external ring gear, respectively, to output power, or the external ring gear to output power.

14. The robot of claim 13, wherein
the first reduction unit comprises a first cylindrical gear and a second cylindrical gear that are in mesh with each other and have rotational centers parallel to each other, and a first bevel gear and a second bevel gear that are in mesh with each other and have rotational centers perpendicular to each other, wherein the first cylindrical gear is coaxially and fixedly connected to an output shaft of the motor unit, and the first bevel gear is coaxially and fixedly connected to the second cylindrical gear, and the second bevel gear is coaxially and fixedly connected to the transmission shaft;
or, the first reduction unit comprises a first cylindrical gear and a second cylindrical gear that are in mesh with each other and have rotational centers parallel to each other, and a third cylindrical gear and a fourth cylindrical gear that are in mesh with each other and have rotational centers parallel to each other, wherein the first cylindrical gear is coaxially and fixedly connected to the output shaft of the motor unit, and the third cylindrical gear is coaxially and fixedly connected to the second cylindrical gear, and the fourth cylindrical gear is coaxially and fixedly connected to the transmission shaft;
or, the first reduction unit comprises at least two cylindrical gear sets, each cylindrical gear set comprising at least two cylindrical gears in mesh with each other.

15. The robot of claim 14, wherein
the double-sided ring gear is fixed to the eccentric wheel via a first bearing; and an internal side of the double-sided ring gear is provided with a toothed surface on one axial segment for meshing with the external ring gear, and is provided with an assembly surface on another axial segment for fixing the first bearing.

16. The robot of claim 15, wherein
the motor unit, the first reduction unit, and the second reduction unit are all arranged inside a base, the internal ring gear is directly fixed inside the base, the external ring gear extends outward from the base to form an output portion, and the external ring gear serves as an output shaft to output power with reduced speed;
or, the external ring gear is fixed to the base, and the internal ring gear serves as an output shaft to output power with reduced speed.

17. The robot of claim 16, wherein
the external ring gear is fixed inside the base via a second bearing; the transmission shaft has one end fixed inside the base via a third bearing and the other end fixed inside the external ring gear via a fourth bearing;
and/or, the motor unit comprises a motor, which is a coreless motor or a brushless motor, a rotary encoder being installed at a rotor end of the motor, and a motor drive circuit board being installed on a lateral side of the motor.

18. The robot of claim 13, wherein
the gear set is arranged vertically such that a force from the motor unit is transmitted vertically;
the transmission shaft is arranged horizontally with its extension direction parallel to an extension direction of the rotor end, forming an n-shaped power transmission structure;
and/or, the motor unit, the first reduction unit, and the second reduction unit are all arranged within a base, the base is provided with a first through-hole for assembling the motor unit and a second through-hole for outputting power, and the first through-hole and the second through-hole are located on the same plane in such a manner that vertical projections of input and output centers of the joint power mechanism coincide, forming a reduction structure with a U-shaped force path.
